(19) United States
(12) Patent Application Publication
(10) Pub. No.: US 2004/0185141 A1
(43) Pub. Date: Sep. 23, 2004

(54) Self-cleaning mold valve with air injection system

(76) Inventors: Alfredo Li Preti, Toronto (CA); Andrej Petricko, Toronto (CA)

Correspondence Address: CARLSON, GASKEY & OLDS, P.C., 400 WEST MAPLE ROAD, SUITE 350, BIRMINGHAM, MI, 48009, US

(21) Appl. No.: 10/781,411

(22) Filed: Feb. 18, 2004

Related U.S. Application Data
(63) Continuation-in-part of application No. 10/394,521, filed on Mar. 21, 2003.

(51) Int. Cl. B29C 45/53

(52) U.S. Cl. 425/561

(57) ABSTRACT

A mold valve assembly includes an air injection system that communicates with the mold valve assembly. The air source provides air into the mold assembly to pressurize a space between the cured molded article and an inner surface of the mold cavity to promote separation of the cured molded article from the mold assembly.

The present application is a Continuation-In-Part of U.S. patent application Ser. No. 10/394,521, filed Mar. 21, 2003 entitled SELF-CLEANING MOLD VALVE FOR A MOLDING SYSTEM.

### BACKGROUND OF THE INVENTION

The present invention relates to a mold valve for a molding system and, more particularly, to a mold valve with a system to assist demolding.

A typical molding system provides for the mixing of at least two materials to form a mixture that is discharged into a mold cavity to form a finished article. The materials are typically fed from a supply by a delivery or feed assembly, which communicates with a mixing head. The materials are mixed by the mixing head and discharged into the mold cavity through a mold valve. The mold assembly and attached mold valve are heated to cure the molded article.

Once the molded article has cured, the molded article must be removed from the mold assembly. Typically knock out pins drive the molded article away from the mold assembly. Disadvantageously, the molded article may adhere to the mold assembly to an extent that the knock out pins may damage the molded article.

Accordingly, it is desirable to provide a mold valve that assists removal of a finished article from the mold assembly.

### SUMMARY OF THE INVENTION

The present invention provides a mold valve assembly, which generally includes a mold valve chamber having an output port and an injection chamber in communication with the mold valve chamber. The mold valve chamber defines a mold valve axis and the injection chamber defines an injection chamber axis. The injection chamber axis is transverse to the mold valve axis. An inlet port in communication with the injection chamber defines an inlet axis angled relative the mold valve axis.

An air injection system communicates with the mold valve assembly. The air source provides an airflow into the mold assembly to pressurizes the space between the cured molded article and the inner surfaces of the mold cavity to promote separation of the cured molded article from within the mold assembly.

The present invention therefore provides a mold valve that assists removal of a finished article from the mold assembly.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a simplified schematic representation of a multiple material molding system having a valve assembly designed according to the present invention;

FIG. 2 is an expanded partial sectional view of a mold valve assembly;

FIG. 3 is a perspective view of the mold valve assembly of FIG. 2;

FIG. 4A is an expanded side view of an injection piston;

FIG. 4B is an expanded top view of the injection piston of FIG. 4A rotated 90 degrees;

FIG. 5A is an exploded view of a mold valve piston of the mold valve assembly according to the present invention;

FIG. 5B is an perspective view of the mold valve piston of FIG. 5A in an assembled condition;

FIG. 6 is a sectional view of the mold valve piston scraping the injection piston during operation of the present invention;

FIG. 7 is a flow chart illustrating operation of the air injection system of the present invention;

FIG. 8 is an expanded partial sectional view of a mold valve assembly with an air injection system; and

FIG. 9 is an expanded partial sectional view of a mold assembly schematically illustrating an air pressure to demold a cured molded article.

### DETAILED DESCRIPTION OF THE PREFERRED EMBODIMENT

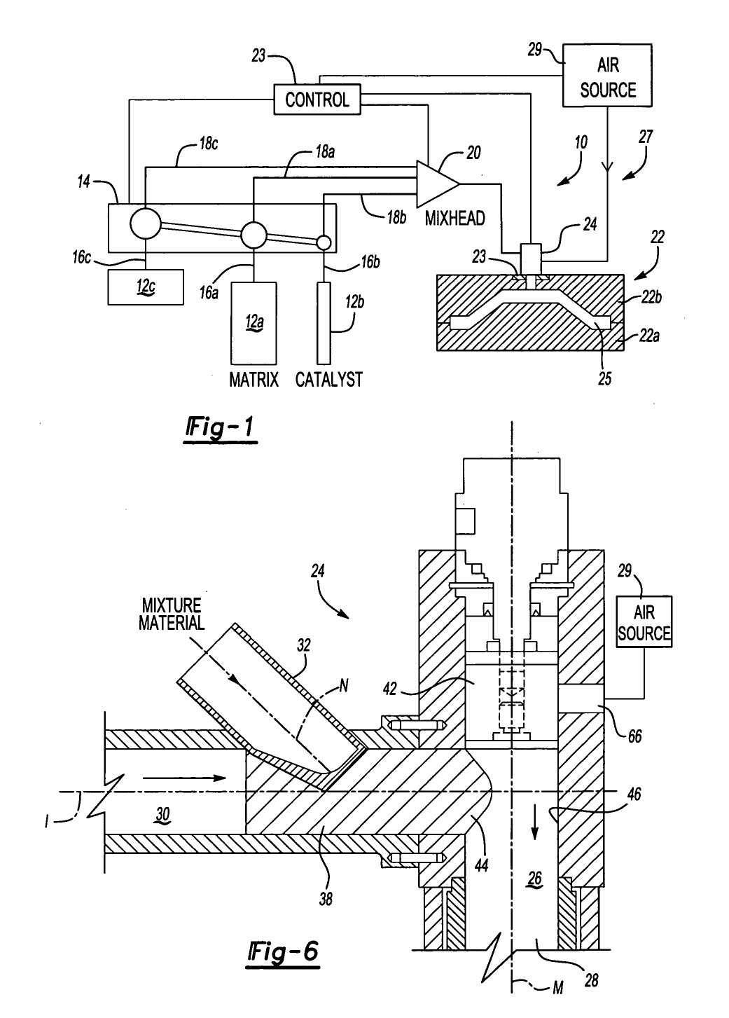

FIG. 1 schematically illustrates a multiple material molding system 10. The system 10 generally includes a plurality of material supplies 12A, 12B and 12C, which communicate with a feed assembly 14 through respective supply conduits 16A-16C. It should be understood that the materials include fluids and solids. The feed assembly 14 drives a desired quantity of material from each material supply 12A-12C through output conduits 18A-18C to a mix head assembly 20. The mix head assembly 20 thoroughly mixes the material from each material supply 12A-12C and injects the mixture material into a mold assembly 22 through a mold valve assembly 24.

The mold assembly 22 preferably includes an A-side base portion 22A and a B-side upper portion 22B which is removed to access a mold cavity 25. The mold valve assembly 24 is typically removably connected to the B-side upper portion 22B.

Preferably, a controller 23 communicates with the feed assembly 14, the mix head assembly 20, and the mold valve assembly 24 to assure the system 10 is operating within predefined parameters. Controls for injection-molding equipment are known in the art and detailed description of the algorithms will not be further detailed herein.

An air injection system 27 includes an air source 29 such as a compressor or the like which communicates with the mold valve assembly 24. The air source 29 provides an airflow into the mold assembly 22 in response to the controller 23. By injection air into the mold assembly 22 after the molded article has cured within the mold cavity 25, the air pressurizes the space between the cured molded article and the inner surfaces of the mold cavity 25 (FIG. 9) to promote separation of the cured molded article from within the mold assembly 22. It should be understood that although air is described in the illustrated embodiment various gases will also benefit from the invention.

The mix head assembly 20 mixes the multiple of materials components, e.g., material matrix, to form a settable mixture, which is then discharged into the mold cavity 25 of the mold assembly 22 through the mold valve assembly 24. The mold valve assembly is then located in an oven or the like to cure the mixture to form an article defined by the mold cavity 25.

Typically, a single mix head 20 feeds the matrix into a multiple of mold assemblies that are arranged in an assembly line like environment. The mold valve assembly 24 is removably mounted to the mold assembly 24 through a coupling 23 or the like.

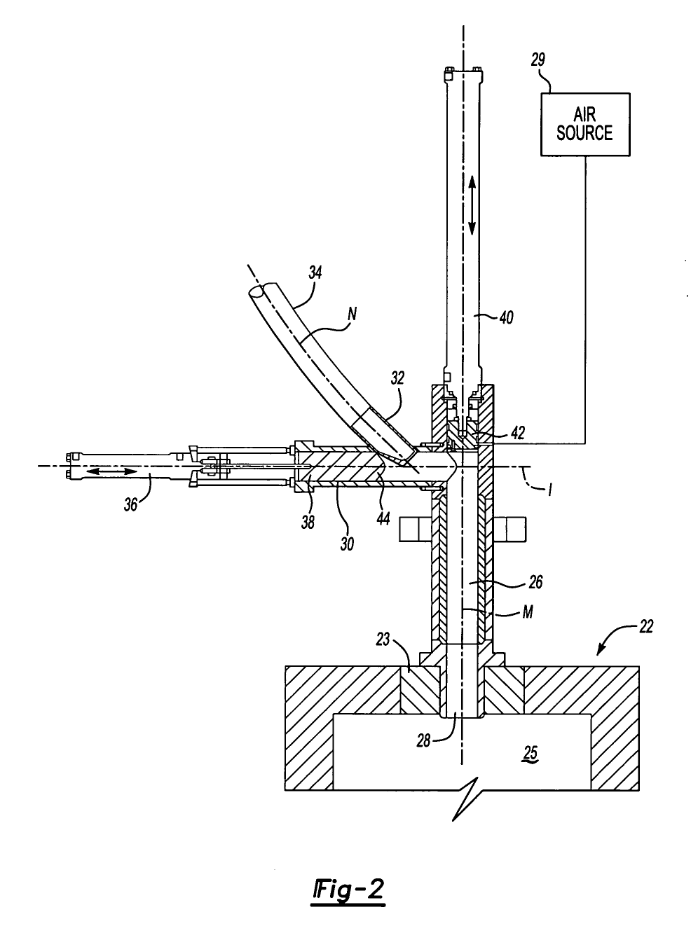

Referring to FIG. 2, a schematic view of the mold valve assembly 24 according to the present invention is illustrated. The mold valve assembly 24 generally includes a mold valve chamber 26 having an output port 28 and an injection chamber 30 in communication with the mold valve chamber 26 (also illustrated in FIG. 3). The mold valve chamber 26 defines a mold valve axis M. The injection chamber 30 defines an injection chamber axis I. The injection chamber axis I is transverse to the mold valve axis M. An inlet port 32 in communication with the injection chamber 30 defines an inlet axis N. The inlet port 32 receives the mixture material from the mix head assembly 20 (FIG. 1) through a conduit 34 or the like.

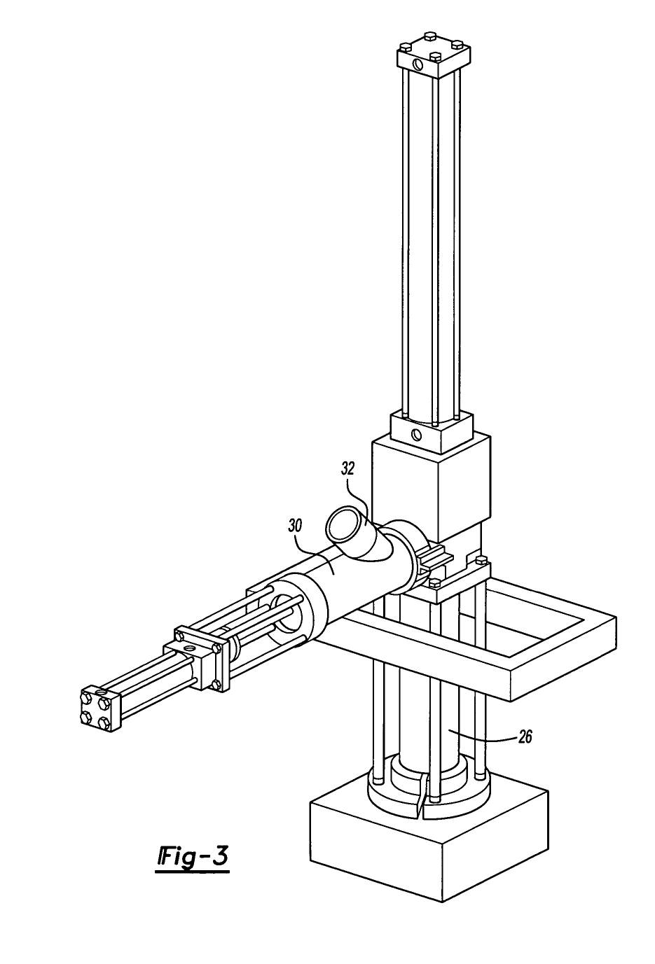

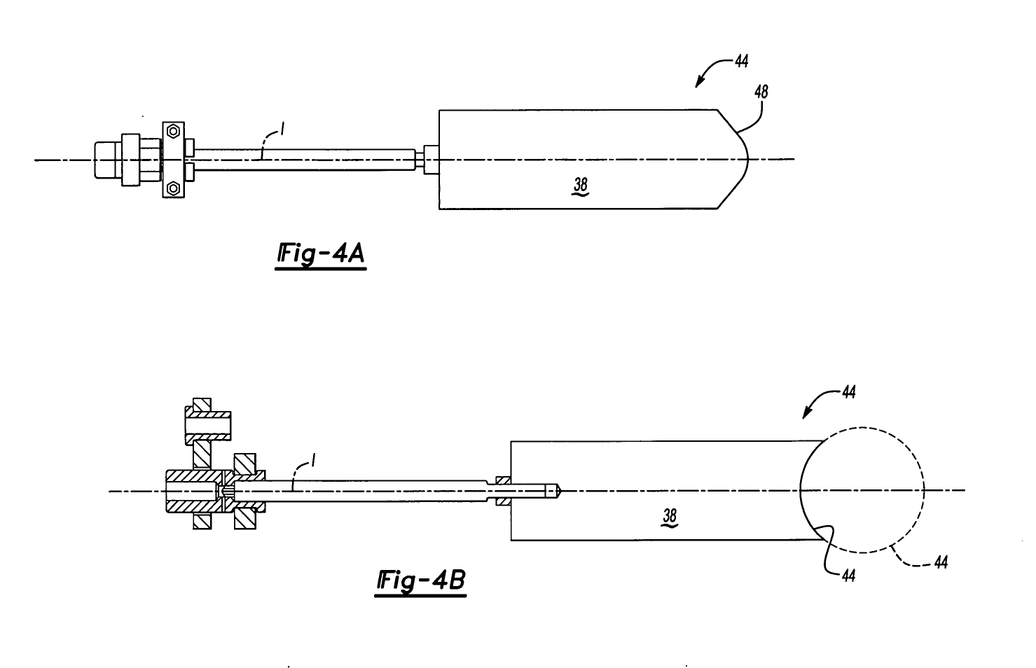

An actuator 36 drives an injection piston 38 (FIGS. 4A, 4B) along the injection chamber axis I within the injection chamber 30 to drive mixture material from the inlet port 32 into the mold valve chamber 26. The actuator 36 is preferably a pneumatic, hydraulic or electric ram, however, various other drive assemblies will also benefit from the present invention.

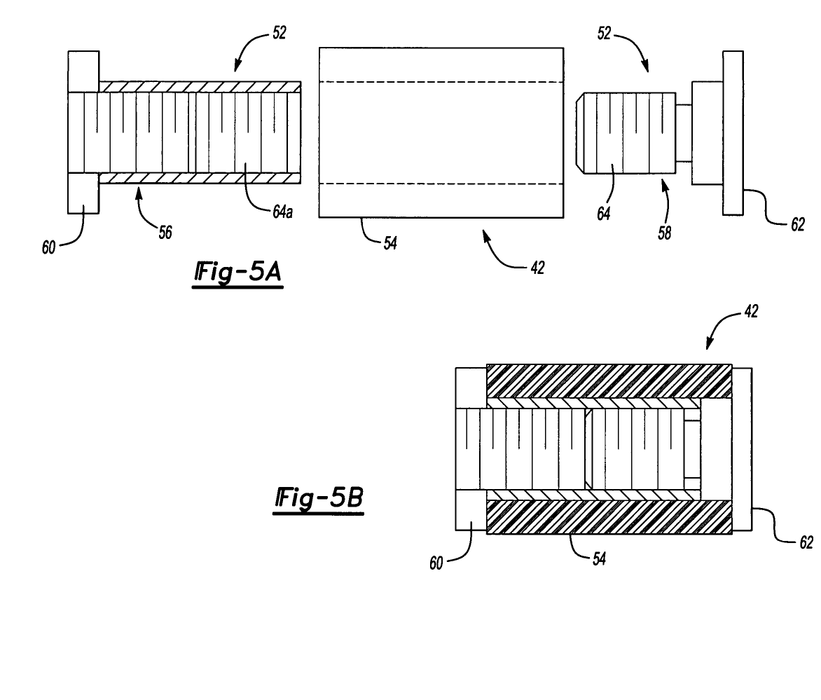

An actuator 40 drives a mold valve piston 42 (FIGS. 5A, 5B) along the mold valve axis M within the mold valve chamber 26 to drive mixture material through the outlet 28 and into the mold cavity 25 of the mold assembly 22. The actuator 40 is preferably a pneumatic, hydraulic, or electric ram; however, various other drive assemblies will also benefit from the present invention. The mold valve piston 42 closely fits within the mold valve chamber 26 and scrapes along an end segment 44 of the injection piston 38 to clean any mixture material remnants therefrom (FIG. 6). That is, the mold valve piston 42 scrapes the mixture material off the end segment 44 and the inner perimeter 46 of the mold valve chamber 26 such that no remnants remain within the mold valve chamber 26. The necessity of flushing between injection cycles is substantially eliminated as the plunger need only be cycled up and down. Cycle time for production and expense of each finished article is thereby decreased.

Referring to FIG. 4A, a side view of the end segment 44 of the injection piston 38 includes an arcuate segment 48 transverse to axis I. A second arcuate segment 50 is defined approximately ninety degrees to the first arcuate segment 48 and defines an apex toward the mold valve chamber 26 (FIG. 6). The configuration of the end segment 44 completes the inner perimeter 46 of the mold valve chamber 26 when fully extended. By completing the inner perimeter 46 of the mold valve chamber 26 where the injection chamber 30 communicates with the mold valve chamber 26, the mold valve piston 42 will scrape along the end segment 44 of the injection piston 38 (FIG. 6).

Referring to FIG. 5A, the mold valve piston 42 includes a metallic support assembly 52 and a nonmetallic member 54. The metallic support assembly 52 is preferably manufactured of 4140 tool steel and the nonmetallic member 54 is preferably manufactured of 25 percent glass filled Teflon. The metallic support assembly 52 includes an upper portion 56 and a lower portion 58. The upper and lower portions 56, 58 are preferably threaded together to retain the cylindrical nonmetallic portion 54 (FIG. 5B).

The upper portion 56 defines an upper cylindrical flange 60 and the lower portion 58 defines a lower cylindrical portion 62. The upper and lower portions 56, 58 are threaded together through complimentary threads 64a, 64b to retain the nonmetallic member 54 therebetween. The upper cylindrical flange 60 and the lower cylindrical portion 62 define an outer diameter which provide a clearance fit with the mold valve chamber 26.

Referring to FIG. 6, the mixture material is injected into the inlet port 32 of the mold valve assembly 24. Once a predefined quantity is injected through mold valve assembly 24, the actuator 36 is initiated by the controller 23 to drive the injection piston 38 along the injection chamber axis I toward the mold valve chamber 26. The injection piston 38 closes off the inlet port 32 to the injection chamber 30 and simultaneously drives the mixture material within the injection chamber 30 into the mold valve chamber 26. The end segment 44 of the injection piston 38 completes the inner perimeter 48 of the mold valve chamber 26 (FIG. 4B).

The actuator 40 is then initiated by the controller 23 to drive the mold valve piston 42 along the mold valve axis M within the mold valve chamber 26 to drive mixture material through an outlet 44 an into the mold cavity 25 of the mold assembly 22. The mold valve piston 42 closely fits within the mold valve chamber 26 and scrapes along the end segment 44 of the injection piston 38 to clean any mixture material remnants therefrom such that no remnants remain within the mold valve chamber 26.

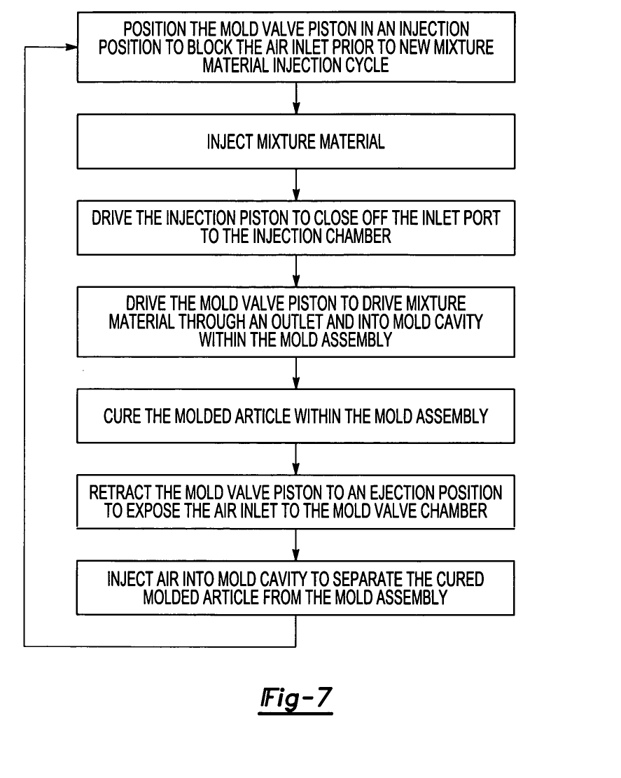

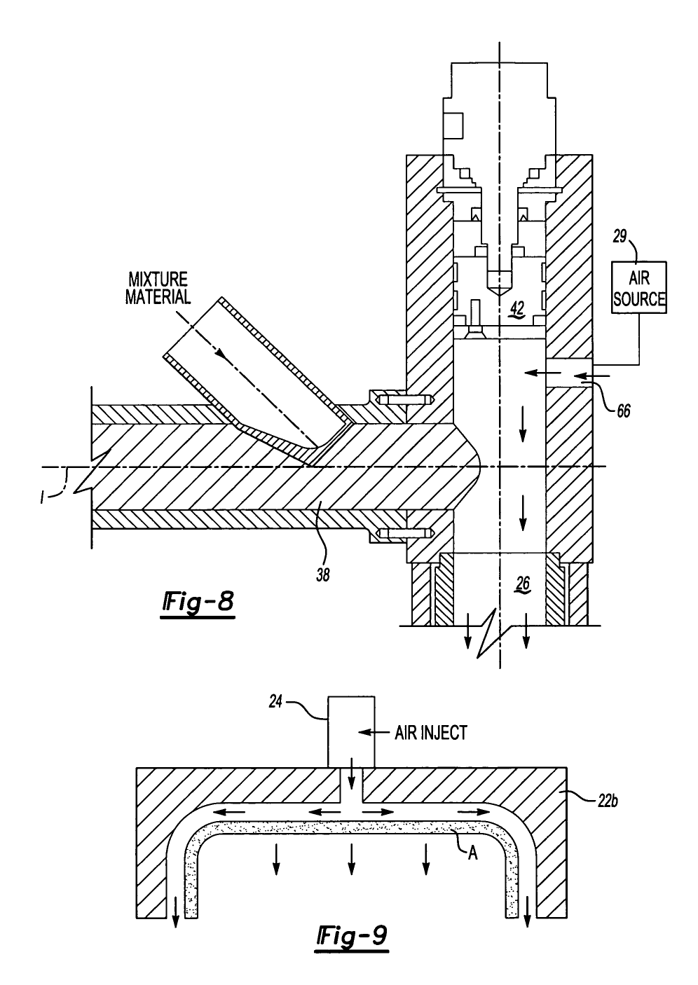

Referring to FIG. 7, once mixture material injection is completed, the molded article is cured within the mold assembly 22. Once the mold article A has cured, the mold valve piston 42 is retracted to an ejection position (FIG. 8) to expose an air inlet 66 to the mold valve chamber 26 and thereby the mold cavity 25. Airflow from the air source 29 is communicated through the mold valve chamber 26 and into the mold cavity 25. The mold assembly 22 is pressurized by the air source 29 to pressurize the space between the cured article A and the mold assembly 22 (FIG. 9).

The pressurized air between the cured article and the mold assembly 22 operates to assist in the separation of the cured molded article from the inner surfaces of the mold assembly 22. It should be understood that knock-out pins (not shown) or the like may additionally be utilized in combination with the pressurization of the mold assembly 22 to further assist separation of the cured molded article from the mold assembly 22. That is, the air pressure frees the cured molded article A from the B-side mold portion prior to separating the B-side mold portion from the A-side mold portion.

Once the cured molded article A is removed from the mold assembly 22, the mold valve piston 42 is retracted to an injection position (FIG. 8) to block the air inlet 66 in preparation for the next mixture material injection cycle. It should be understood that the mold valve piston 42 selectively blocks or opens air inlet 66 to control air flow into the mold assembly 22; however, separate control of the air flow may alternatively and/or additionally be provided.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A mold valve assembly for a molding system comprising:
a mold valve chamber comprising an output port, said mold valve chamber defining a first axis;
an injection chamber in communication with said mold valve chamber, said injection chamber defining a second axis transverse to said first axis;
an injection piston movable within said injection chamber, an end segment of said injection piston movable to define a portion of a mold valve chamber inner perimeter; and
an air injection system in communication with said mold valve chamber.

2. The mold valve assembly as recited in claim 1, wherein said air injection system comprises an air source in communication with an air inlet through said mold valve chamber.

3. The mold valve assembly as recited in claim 1, further comprising a mold valve piston movable within said mold valve chamber.

4. The mold valve assembly as recited in claim 3, wherein said mold valve piston is selectively movable to block an air inlet through said mold valve chamber.

5. The mold valve assembly as recited in claim 4, wherein said mold valve piston scrapes said end segment as said mold valve piston moves toward said output port.

6. A molding system comprising:
a mold assembly which defines a mold cavity;
a mold valve assembly selectively mountable to said mold assembly; and
an air injection system in communication with said mold valve assembly to selectively inject air into said mold cavity.

7. The molding system as recited in claim 6, further comprising a mix head assembly in communication with said mold valve assembly.

8. The molding system as recited in claim 7, further comprising a feed assembly in communication with said mix head assembly.

9. The molding system as recited in claim 6, wherein said mold valve assembly comprises:
a mold valve chamber comprising an output port, said mold valve chamber defining a first axis;
an injection chamber in communication with said mold valve chamber, said injection chamber defining a second axis transverse to said first axis; and
an injection piston movable within said injection chamber, an end segment of said injection piston movable to define a portion of a mold valve chamber inner perimeter.

10. The molding system as recited in claim 9, wherein said air injection system communicates with said mold valve chamber.

11. A method for injecting matrix into a mold assembly through a mold valve assembly comprising an injection chamber and mold valve chamber, the method comprising the steps of:
(a) injecting a mixture material into the mold assembly through the injection chamber and the mold valve chamber;
(b) driving the mixture material into the mold valve chamber with a first piston;
(c) driving the mixture material from the mold valve chamber into the mold assembly with a second piston;
(d) curing the mixture material to form a cured article within the mold assembly;
(e) retracting the second position to an ejection position; and
(f) injecting air through the mold valve chamber into the mold assembly between the cured article and the mold assembly.

12. A method as recited in claim 11, further comprising the step of:
orienting an axis defined by the first piston transverse to a second axis defined by the second piston.

13. A method as recited in claim 11, further comprising the step of:
locating the second piston at an injection position prior to said step (a).

14. A method as recited in claim 13, wherein said step (e) comprises:
retracting the second piston past the injection position.
